(19) United States
(12) Patent Application Publication
(10) Pub. No.: US 2012/0167309 A1
(43) Pub. Date: Jul. 5, 2012

(54) Bed bug monitoring device

(76) Inventor: Brian D. Heidorn, Lincoln, NE (US)

(21) Appl. No.: 12/930,225

(22) Filed: Dec. 30, 2010

(51) Int. Cl. A47C 23/00; A01M 1/20; A01M 1/14; A47G 9/02

(52) U.S. Cl. 5/691; 5/485; 43/123; 43/114

(57) ABSTRACT

A plurality of bed bug monitoring and/or trapping devices are secured to the side portions and end portions of a fitted bed sheet or are secured to the side portions and end portions of a box spring. Each of the devices includes a pocket having a fluted member inserted therein.

### BACKGROUND OF THE INVENTION

1. Field of the Invention

This invention relates to a bed bug monitoring device and more particularly to bed bug monitoring devices which are secured to the opposite side portions and opposite end portions of a fitted bed sheet in a spaced-apart manner. The invention may also be secured to the sides and ends of a box spring. The devices may also serve as traps.

2. Description of the Related Art

There has been a recent surge in infestations and problems with the common bed bug (Cimex Lectularius). There is a legitimate need for both an effective means to identify a bed bug population and treat the issue. The use of many strong “kill-all” pesticides which have proven useful in years past are no longer considered safe and have been removed from the marketplace. There exists many types of bed bug traps and monitors from chemical to mechanical, active and passive. Most of the prior art bed bug traps and monitors are utilized around the bed frame and legs of a bed. It is common knowledge that bed bugs may be actively feeding and still not be detected by the prior art monitors and traps.

Bed bugs have certain behavior patterns which are pertinent to the monitoring and trapping of bed bugs. The preferred food for bed bugs is human blood and they usually feed at night. Bed bugs usually feed on sleeping or resting hosts and prefer to hide when not active. Bed bugs also prefer to spend time wedging headfirst into tight spaces.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In the preferred embodiment of this invention, a fitted bed sheet is provided which is positioned on a mattress. The fitted bed sheet includes a top portion, opposite end portions and opposite side portions. The bed sheet also includes an elastic band or cord which maintains the bed sheet on the mattress in conventional fashion.

A plurality of horizontally spaced-apart pockets are secured to the opposite end portions and opposite side portions of the bed sheet. Each of the pockets is comprised of a flexible, clear plastic material and has an upper end, a lower end, and opposite side edges. The opposite side edges of each of the pockets are secured to the bed sheet. The upper end of each of the pockets is open. In the preferred embodiment, the lower ends of each of the pockets are partially closed.

A flat fluted cardboard member is selectively removably positioned in each of the pockets. Each of the flat fluted cardboard members have spaced-apart and vertically disposed flutes formed therein with the upper ends of the flutes being positioned adjacent the upper end of the associated pocket and with the lower ends of the flutes being positioned adjacent the open portion of the lower end of the associated pocket whereby bed bugs may enter the flutes at either the upper or lower ends thereof. The pockets and cardboard members form monitors or traps.

In a second embodiment of the invention, each of the pockets has an inverted trapezoidal shape and each of the members positioned therein has an inverted trapezoidal shape. If desired, each of the fluted members may have an insecticide associated therewith or may have an adhesive associated therewith. In a further embodiment of the invention, the monitors are placed on the ends and side walls of a box spring. In a further embodiment of the invention, the monitors are placed on the ends and side walls of a box spring.

It is therefore a principal object of the invention to provide an improved bed bug monitoring device.

A further object of the invention is to provide bed bug monitoring devices which are attached to the end portions of a bed sheet and which are attached to the side portions of a bed sheet.

A further object of the invention is to provide a bed bug monitoring device wherein the fluted members are removably positioned in pockets spaced along the sides and ends of the bed sheet.

A further object of the invention is to provide a bed bug monitoring device which is convenient to use.

A further object of the invention is to provide a bed bug monitoring device which does not interfere with normal sleeping habits of a person or persons utilizing the bed sheet.

A further object of the invention is to provide a bed bug monitoring and/or trapping device which may be mounted on either a fitted bed sheet or on a box spring.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a top perspective view illustrating the bed bug monitoring system of this invention mounted on a bed sheet positioned on a bed sheet positioned on a mattress;

FIG. 2 is a bottom perspective view illustrating the bed bug monitoring system of FIG. 1;

FIG. 3 is an exploded perspective view of one of the monitoring stations of this invention;

FIG. 4 is a perspective view of one of the monitoring stations of this invention;

FIG. 5 is an exploded perspective view of a modified monitoring station;

FIG. 6 is a perspective view of a box spring having the monitoring devices attached thereto; and

FIG. 7 is a partial perspective view of a modified form of the invention.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers to a conventional bed sheet which preferably is a fitted bed sheet. Bed sheet 10 includes a top portion 12, opposite end portions 14 and 16, and opposite side portions 18 and 20. If the bed sheet 10 is a fitted bed sheet, the bed sheet 10 includes an elastic cord or band 20 for drawing the bed sheet 10 around a mattress 22 having a top portion, a bottom portion, opposite end portions and opposite side portions.

A plurality of horizontally spaced-apart pockets 24 are secured to the end portions 14 and 16 and the side portions 18 and 20. The pockets 24 are preferably comprised of a flexible, clear plastic material. Pockets 24 could also be comprised of a translucent plastic material or a non-transparent material.

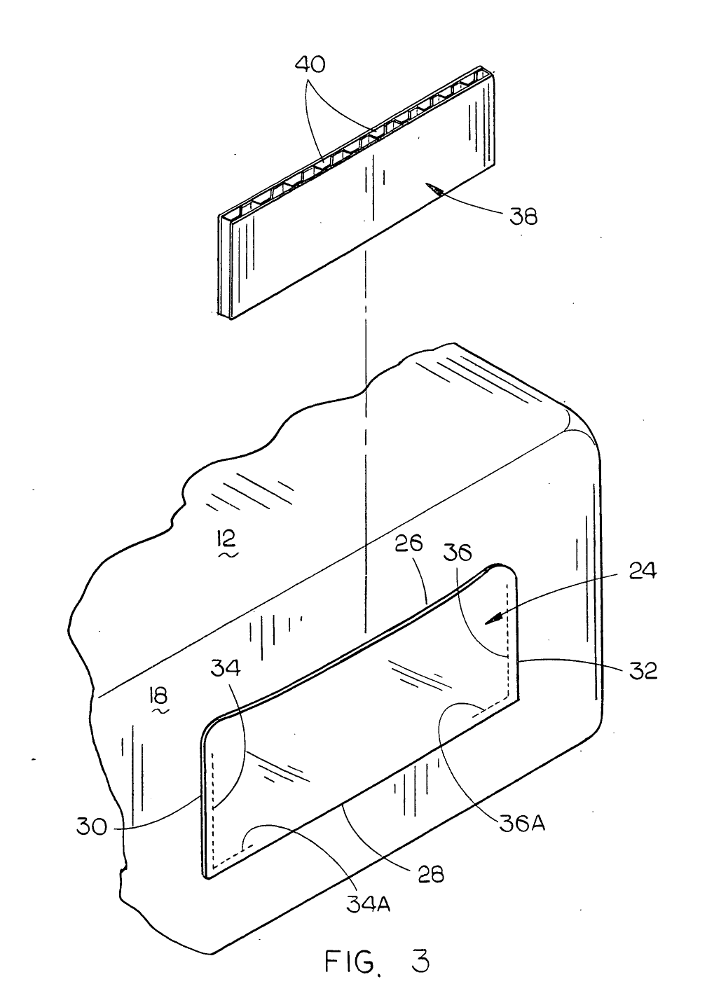

Each of the pockets 24 has an open upper end 26 and a partially open lower end 28. Pockets 24 also have opposite side edges 30 and 32 which are secured to the sheet 10 by stitching 34 and 36 respectively. As seen in FIG. 3, the stitching 34 has a laterally extending portion 34A and stitching 36 has a laterally extending portion 36A. Laterally extending portions 34A and 36A partially close the lower end 28 of pocket 24.

A flat, fluted cardboard member 38 is selectively removably positioned in each of the pockets 24. The flutes 40 of the member 38 are vertically disposed so that the open upper ends of the flutes 40 are positioned adjacent the upper end 26 of pocket 24 and so that the open lower ends of the flutes 40 are disposed adjacent the lower end 28 of pocket 24. the stitching portions 34A and 36A prevent the member 38 from passing downwardly through the lower end 28 of pocket 24.

Although it is preferred that the members 38 be constructed of cardboard, they could be comprised of a plastic material as well. Although it is preferred that flat fluted members 38 be utilized, the members 38 could be comprised of any collection device having a space into which the bed bugs may enter. One such member could be paper or non-fluted cardboard folded upon itself to create a space or chamber. In addition to the pockets 24 and members 38 serving as bed bug monitoring devices, an insecticide could be placed in the flutes 40 to eradicate bed bugs coming into contact therewith. Further, chemical attractants or chemical deterrents could be placed in the flutes. Further, the pockets 24 and members 38 could also be used to trap bed bugs therein by injecting glue or adhesive therein.

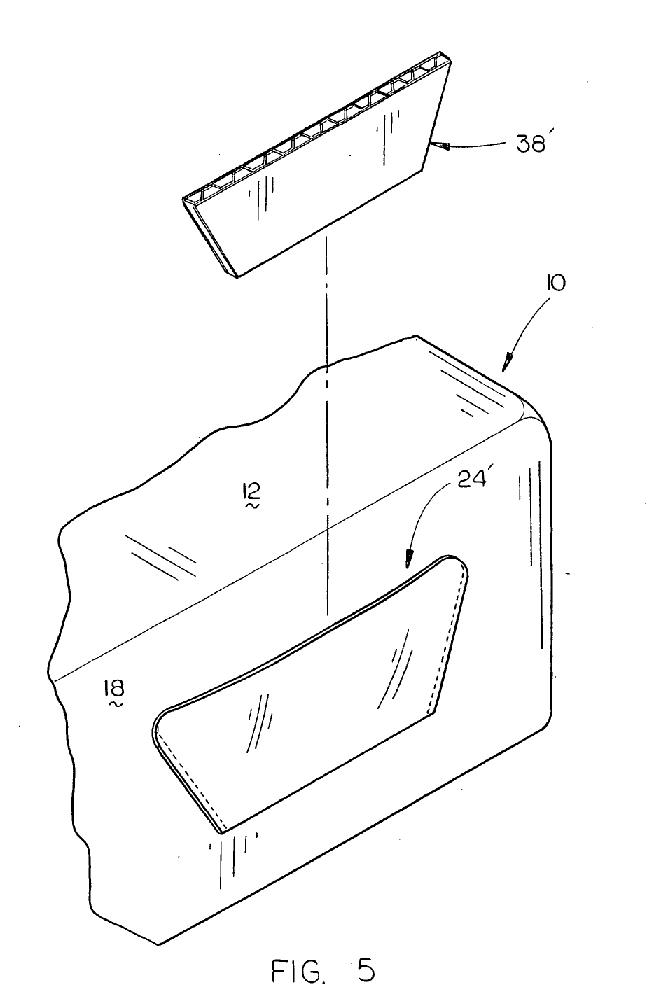

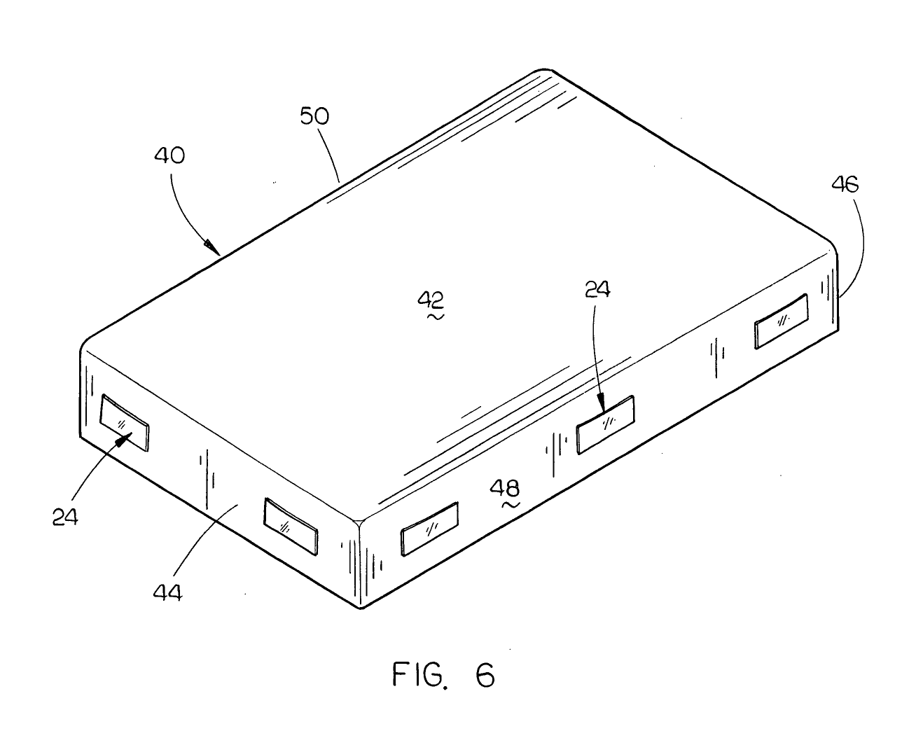

A modified form of the invention is disclosed in FIG. 5. As seen, the pockets 24′ have an inverted trapezoidal shape as do the members 38′. In the invention of FIG. 5, the inverted trapezoidal shape of the pocket 24′ prevents the member 38′ from passing downwardly from the lower end of pocket 24′. Although it is preferred that the pockets 24 are placed on the outer surfaces of the bed sheet, the pockets 24 could be positioned on the inside surfaces of the sheet.

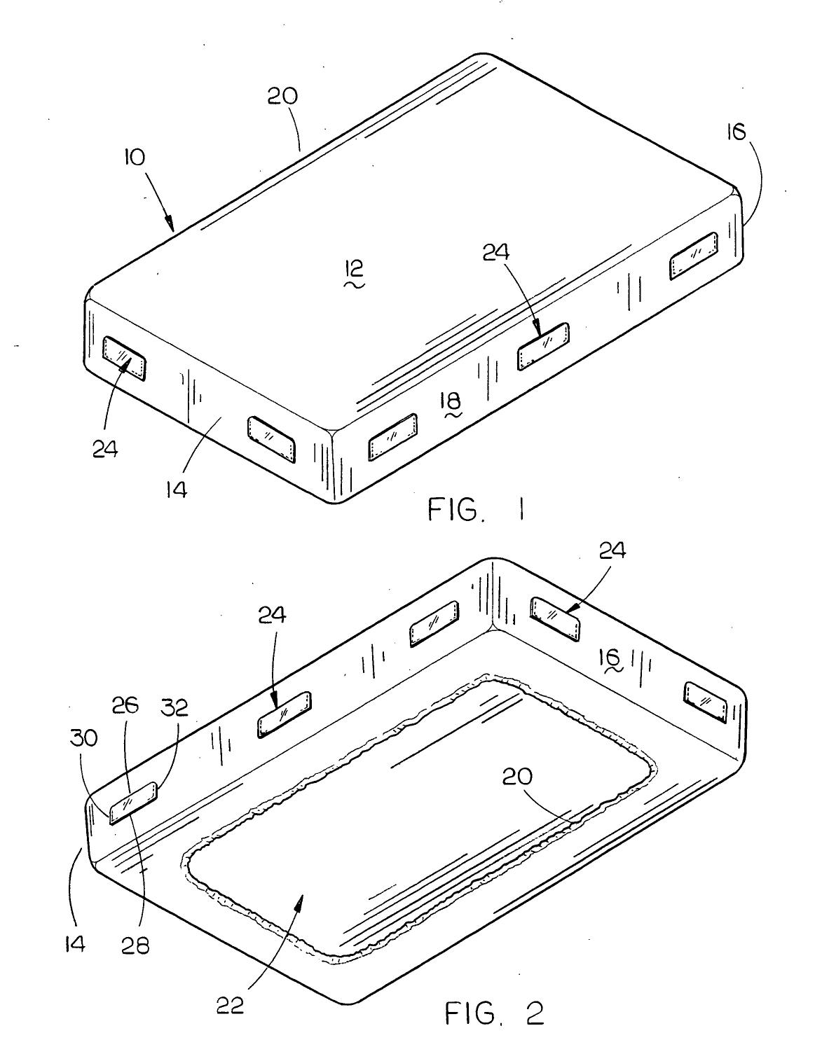

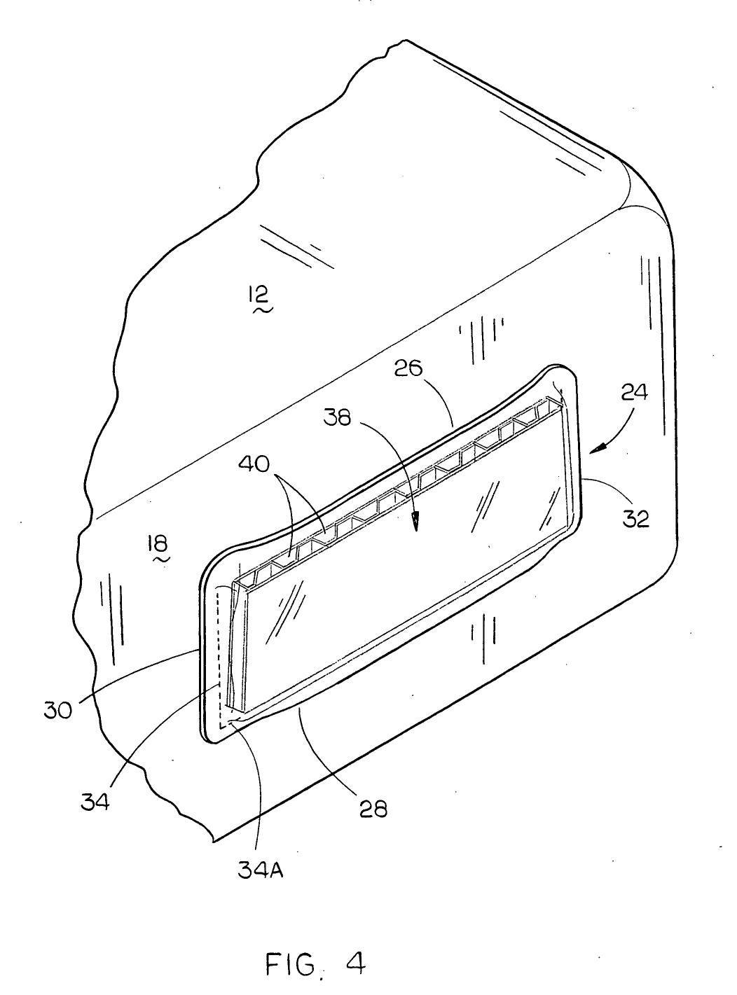

FIG. 6 illustrates the monitoring devices of this invention mounted on a box spring 40. Box spring 40 includes a top portion 42, opposite end portions 44 and 46 and side portions 48 and 50. The pockets 24 are secured to the end portions and side portions of the box spring 40 by any convenient means such as by adhesive, stitching, etc. The pockets 24 will have the cardboard members positioned therein as described in FIGS. 1-5.

The pockets 24 are positioned on either the bed sheet or the box spring based on the principal that bed bugs need to feed and therefore the most likely place to try to set a trap or monitor for them is as close to the human host as possible. The pockets 24 create an ideal harborage for the bed bugs to provide a place for them to hide. It is anticipated that the monitoring devices may also be used to trap the bed bugs therein as described above.

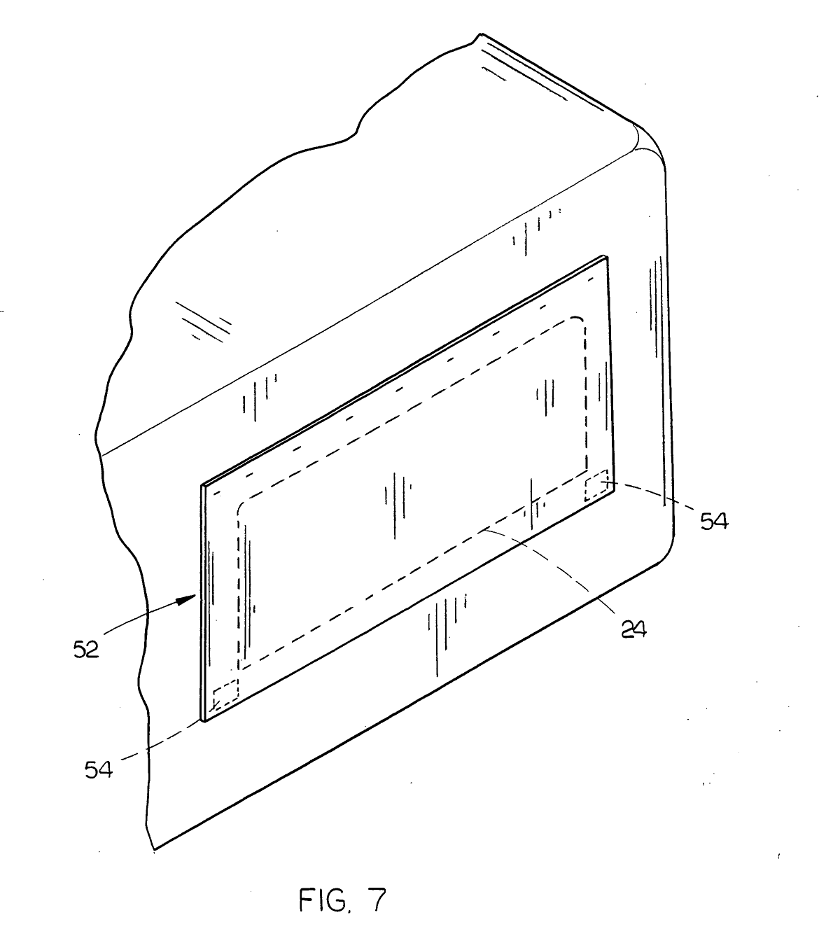

FIG. 7 illustrates a further embodiment of the invention. In FIG. 7, a flexible flap 52 is positioned over each of the pockets 24 to visually “hide” the pockets 24 from public view such as in hotels or the like. In FIG. 7, the flap 52 is positioned over the pocket 24 so as to leave space for the bed bugs to enter the pocket 24. The flap is releasably held in position by VELCRO® strips 54 or the like which permit the flap to be lifted away from the pocket 24 for visual inspection of the pocket 24.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. In combination with a mattress having a top portion, opposite end portions, opposite side portions and a bottom portion;
a bed sheet on the mattress which includes a top portion; vertically disposed opposite end portions, and vertically disposed opposite side portions;
said opposite end portions and said opposite side portions having upper and lower ends;
a plurality of horizontally spaced-apart pockets secured to said opposite end portions and said opposite side portions of said bed sheet;
each of said pockets having an upper end, a lower end, and opposite side edges;
said opposite side edges of each of said pockets being secured to said bed sheet;
said upper end of each of said pockets being open;
said lower end of each of said pockets being partially closed;
and a flat fluted cardboard member selectively removably positioned in each of said pockets;
said flat fluted cardboard member having spaced-apart vertically disposed flutes found therein with the upper ends of said flutes being positioned adjacent said upper end of the associated pocket and with the lower ends of said flutes being positioned adjacent the open portion of said lower end of the associated pocket whereby bed bugs may enter the flutes at either the upper or lower ends thereof.

2. The combination of claim 1 wherein said bed sheet is a fitted bed sheet including means for maintaining said bed sheet on the mattress.

3. The combination of claim 1 wherein said pockets are comprised of a clear plastic material.

4. The combination of claim 1 wherein said pockets are comprised of a flexible plastic material.

5. The combination of claim 1 wherein each of said pockets are generally rectangular in shape with the longitudinal axis thereof being substantially horizontally disposed.

6. The combination of claim 1 further including an insecticide in said flutes.

7. The combination of claim 1 further including an adhesive in said flutes to trap bed bugs therein.

8. The combination of claim 1 further including a flap which selectively covers each of said pockets.

9. In combination with a mattress having a top portion, opposite end portions, opposite side portions and a bottom portion;
a bed sheet on the mattress which includes a top portion; vertically disposed opposite end portions, and vertically disposed opposite side portions;
said opposite end portions and said opposite side portions having upper and lower ends;
a plurality of horizontally spaced-apart pockets secured to said opposite end portions and said opposite side portions of said bed sheet;
each of said pockets having an upper end, a lower end, and opposite side edges;
said opposite side edges of each of said pockets being secured to said bed sheet;
said upper end of each of said pockets being open;
said lower end of each of said pockets being open;
and a flat fluted cardboard member selectively removably positioned in each of said pockets;
said flat fluted cardboard member having spaced-apart vertically disposed flutes found therein with the upper ends of said flutes being positioned adjacent said upper end of the associated pocket and with the lower ends of said flutes being positioned adjacent the lower end of the associated pocket whereby bed bugs may enter the flutes at either the upper or lower ends thereof;
each of said pockets having an inverted trapezoidal shape; and
each of said flat fluted cardboard members having an inverted trapezoidal shape.

10. The combination of claim 9 wherein said bed sheet is a fitted bed sheet including means for maintaining said bed sheet on the mattress.

11. The combination of claim 9 wherein said pockets are comprised of a clear plastic material.

12. The combination of claim 9 wherein said pockets are comprised of a flexible plastic material.

13. The combination of claim 9 further including an insecticide in said flutes.

14. The combination of claim 9 further including an adhesive in said flutes to trap bed bugs therein.

15. The combination of claim 9 further including a flap which selectively covers each of said pockets.

16. In combination:
a box spring mattress having a top portion, opposite end portions, opposite side portions and a bottom portion;
said opposite end portions and said opposite side portions of said box spring having upper and lower ends;
a plurality of horizontally spaced-apart pockets secured to said opposite end portions and said opposite side portions of said box spring;
each of said pockets having an upper end, a lower end, and first and second side edges;
said first and second side edges of each of said pockets being secured to said box spring;
said upper and lower ends of each of said pockets being open;
and a flat fluted cardboard member selectively removably positioned in each of said pockets;
said flat fluted cardboard member having spaced-apart vertically disposed flutes found therein with the upper ends of said flutes being positioned adjacent said upper end of the associated pocket and with the lower ends of said flutes being positioned adjacent the open portion of said lower end of the associated pocket whereby bed bugs may enter the flutes at either the upper or lower ends thereof.

17. The combination of claim 16 wherein said pockets are comprised of a clear plastic material.

18. The combination of claim 16 wherein said pockets are comprised of a flexible plastic material.

19. The combination of claim 16 wherein each of said pockets are generally rectangular in shape with the longitudinal axis thereof being substantially horizontally disposed.

20. The combination of claim 16 further including an insecticide in said flutes.

21. The combination of claim 16 further including an adhesive in said flutes to trap bed bugs therein.

22. The combination of claim 16 wherein the lower end of each of said pockets is partially closed.

23. In combination:
a box spring mattress having a top portion, opposite end portions, opposite side portions and a bottom portion;
said opposite end portions and said opposite side portions of said box spring having upper and lower ends;
a plurality of horizontally spaced-apart pockets secured to said opposite end portions and said opposite side portions of said box spring;
each of said pockets having an upper end, a lower end, and first and second side edges;
said first and second side edges of each of said pockets being secured to said box spring;
said upper and lower ends of each of said pockets being open;
and a bed bug collection member selectively removably positioned in each of said pockets whereby bed bugs may enter said bed bug collection member.

24. The combination of claim 23 wherein a flap is selectively positioned over each of said pockets.
